(19) United States
(12) Patent Application Publication
(10) Pub. No.: US 2020/0141184 A1
(43) Pub. Date: May 7, 2020

(54) FOOT-ASSISTED MOVABLE ENGINEERING LADDER

(71) Applicant: Neng Liu, Changde (CN)

(72) Inventor: Neng Liu, Changde (CN)

(21) Appl. No.: 16/671,139

(22) Filed: Oct. 31, 2019

(30) Foreign Application Priority Data
Nov. 7, 2018 (CN) 201821822419.5

(51) Int. Cl. E06C 1/397; E06C 1/18; E06C 1/383; E06C 1/393

(52) U.S. Cl. CPC E06C 1/397; E06C 1/393; E06C 1/383; E06C 1/18

(57) ABSTRACT

The invention discloses a foot-assisted movable engineering ladder, comprising a herringbone ladder body, which comprises left and right ladder bodies hinged with each other at the top; the left body has a plurality of left steps in parallel from top to bottom, and the right body has right steps corresponding to the left steps; the bottom of left and the right bodies have guiding wheels. Advantageous: a power assist component is added, enabling that the direction and position of the ladder can be moved in construction, reducing the worker's movements to carry the ladder, which is labor and time consuming. The invention is mainly used for construction, water and electricity installation, decoration, oil painting, painting, etc.

### BACKGROUND OF THE INVENTION

### 1. Field of the Invention

The invention relates to the technical field of ladders, and in particular to a foot-assisted movable engineering ladder.

### 2. Description of the Related Art

In daily life, the ladder is a common tool for manual high-place operation. In the actual work process, the worker often need to take the components to be assembled in hand, at the same time, they need to move the ladder, so that the worker have to move up and down and carry the ladder to move, which it is both time and labor consuming, and is inconvenient in actual use.

### SUMMARY OF THE INVENTION

In order to solve the technical issues above, the invention provides the technical solutions as follows: a foot-assisted movable engineering ladder, comprising a herringbone ladder body, wherein the ladder body comprises a left ladder body and a right ladder body hinged with each other at the top; the left ladder body is provided with a plurality of left steps in parallel from top to bottom, and the right ladder body is provided with a plurality of right steps corresponding to the left steps in parallel from top to bottom; the bottom of the left ladder body and the right ladder body are respectively provided with guiding wheels;

the upper portion of the left ladder body close to the hinging portion with the right ladder body is provided with a power assist component; the power assist component comprises a left power assist rod hinged with the left ladder body at one end and a right power assist rod hinged with the right ladder body at one end; the other end of the left power assist rod is hinged with one end of the right power assist rod to form an A-shaped ladder body; the outer surface of the left power assist rod is further provided with a power assist hinging piece connected to the outer surface of the right power assist rod;

a left power assist footboard from which left steps can be extended is hinged in the left power assist rod, and a right power assist footboard from which right steps can be extended is hinged in the right power assist rod; the left power assist footboard is provided with a first reset spring connected to the top of the right ladder body; a left power assist push rod is hinged downward on the end of the left power assist footboard close to the right power assist footboard, and the top of the left power assist push rod is further provided with a left hinging piece hinged with the left ladder body; the left power assist footboard can move up and down around the hinging portion of the left power assist rod and drive the left power assist push rod to move; the right power assist footboard is provided with a second reset spring connected to the top of the left ladder body; a right power assist push rod is hinged downward on the end of the right power assist footboard close to the left power assist footboard, and the top of the right power assist push rod is further provided with a right hinging piece hinged with the right ladder body; the right power assist footboard can move up and down around the hinging portion of the right power assist rod and drive the right power assist push rod to move.

As an improvement, the left power assist footboard and the right power assist footboard have the same structure; the left power assist footboard comprises an outer frame, and a cross bar is disposed at the middle of the outer frame to divide the outer frame into a connecting portion and a foot portion; the foot portion is provided with a plurality of foot rods perpendicular to the cross bar; the outer side of the end of the connecting portion away from the foot portion is hinged with the inner wall of the left power assist rod, and the inner side thereof is hinged with the top of the left power assist push rod; the cross bar is connected to the end of the first reset spring.

As an improvement, the foot portion of the left power assist footboard is extended out of the left step, and left steps are all disposed at the lower portion of the left power assist footboard, and the left step at the top is disposed at the lower portion of the left power assist footboard and abuts the left power assist footboard.

As an improvement, one end of the left hinging piece is hinged with the connecting portion of the left power assist rod and the left ladder body, and the other end thereof is hinged with a first hinging hook; the surface of the left power assist push rod is provided with a first hinging bolt corresponding to the first hinging hook, so that the left hinging piece and the left power assist push rod are detachably connected.

As an improvement, one end of the power assist hinging piece is hinged with the outside of the left power assist rod, and the other end thereof is provided with a second hinging hook; the outside of the right power assist rod is provided with a second hinging bolt corresponding to the second hinging hook, so that the right power assist rod and the power assist hinging piece are detachably connected.

As an improvement, the bottom of the left power assist push rod and the right power assist push rod are further provided with a non-slip cover for increasing friction.

As an improvement, a seat is provided on the top hinging portion of the left ladder body and the right ladder body. The worker can sit or stand on the power assist footboard, and tools such as ash buckets can be placed on the power assist footboard.

As an improvement, the left hinging piece of the left ladder body and the right hinging piece of the right ladder body are both provided with a decoupling distance adjustment orifice, so that the movement distance of the ladder can be appropriately adjusted.

As an improvement, the lower portion of the left power assist push rod and the right power assist push rod are provided with a foldable hinging chain, which can shorten the length of the power assist push rod, and fit the fold of the movable ladder for convenient carrying.

After adapting the above structure, the invention has the following advantageous: a power assist component is added to the movable herringbone ladder, which enables that the direction and position of the ladder of the invention can be moved in construction, reducing the worker's up and down movements to carry the ladder back and forth, which is both labor and time consuming. The invention is mainly used for construction, water and electricity installation, decoration, oil painting, painting, etc.; at the same time, it can be widely used in high-level communication wiring, library books arranging, pharmacy medicine picking up and other small high-level work, which is time and labor saving, and is suitable for professional production and marketing.

### BRIEF DESCRIPTION OF THE DRAWINGS

FIG. 1 is a schematic view illustrating the structure of the foot-assisted movable engineering ladder of the invention.

FIG. 2 is a schematic view illustrating the structure of the power assist component of the foot-assisted movable engineering ladder of the invention.

FIG. 3 is a top view illustrating the structure of the left power assist footboard and the right power assist footboard of the foot-assisted movable engineering ladder of the invention.

FIG. 4 is a side view illustrating the structure of the foot-assisted movable engineering ladder of the invention in a folded state.

FIG. 5 is a stereogram illustrating the structure of the foot-assisted movable engineering ladder of the invention in a folded state.

FIG. 6 is an enlarged view illustrating the structure of the left hinging piece of the foot-assisted movable engineering ladder of the invention.

As shown in the figures: 1 refers to the left ladder body; 1.1 refers to the left step; 2 refers to the right ladder body; 2.1 refers to the right step; 3 refers to the guiding wheel; 4 refers to the power assist component; 4.1 refers to the left power assist rod; 4.2 refers to the right power assist rod; 4.2a refers to the second hinging bolt; 4.3 refers to the power assist hinging piece; 4.4 refers to the left power assist footboard; 4.4a refers to the outer frame; 4.4b refers to the cross bar; 4.4c refers to the connecting portion; 4.4d refers to the foot portion; 4.4e refers to the foot rod; 4.5 refers to the right power assist footboard; 4.6 refers to the first reset spring; 4.7 refers to the left power assist push rod; 4.7a refers to the first hinging bolt; 4.8 refers to the left hinging piece; 4.9 refers to the second reset spring; 4.10 refers to the right power assist push rod; 4.11 refers to the right hinging piece; 4.12 refers to the foldable hinging chain; 5 refers to the seat.

### DETAILED DESCRIPTION OF THE PREFERRED EMBODIMENTS

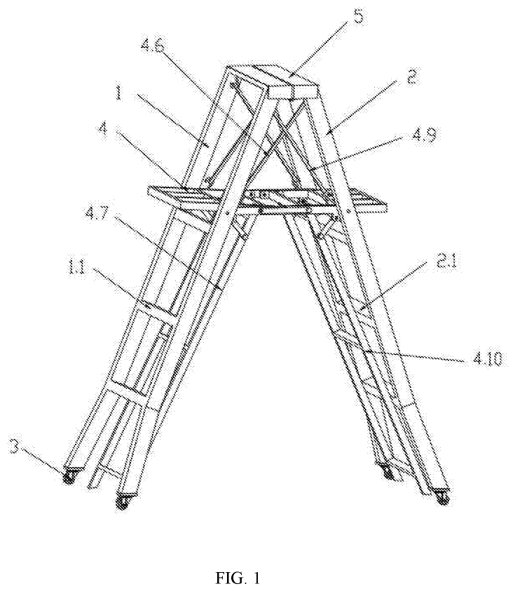

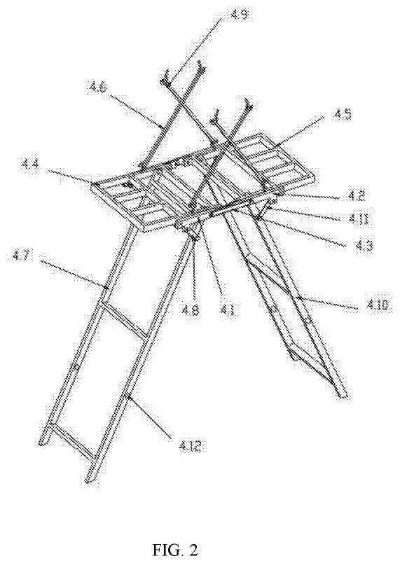

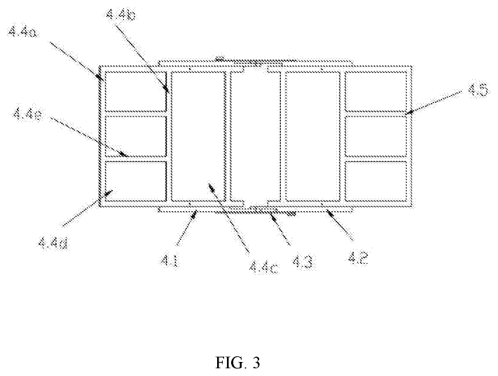

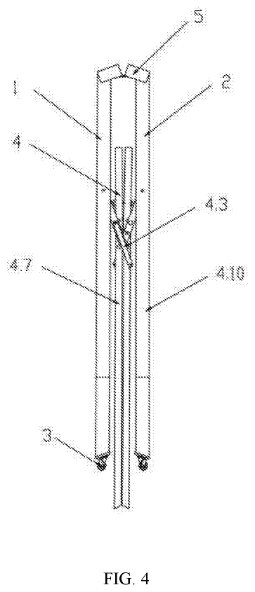

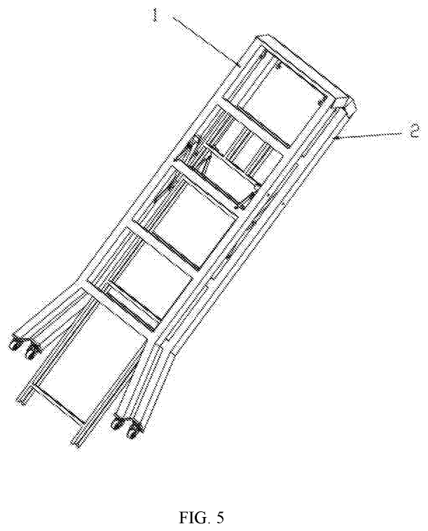

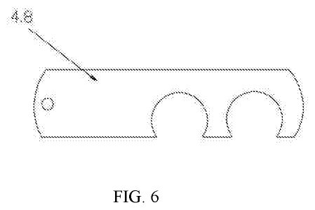

With reference to FIG. 1-6, a foot-assisted movable engineering ladder, comprising a herringbone ladder body, wherein the ladder body comprises a left ladder body 1 and a right ladder body 2 hinged with each other at the top; the left ladder body 1 is provided with a plurality of left steps 1.1 in parallel from top to bottom, and the right ladder body 2 is provided with a plurality of right steps 2.1 corresponding to the left steps 1.1 in parallel from top to bottom; the bottom of the left ladder body 1 and the right ladder body 2 are respectively provided with guiding wheels 3;

the upper portion of the left ladder body 1 close to the hinging portion with the right ladder body 2 is provided with a power assist component 4; the power assist component 4 comprises a left power assist rod 4.1 hinged with the left ladder body 1 at one end and a right power assist rod 4.2 hinged with the right ladder body 2 at one end; the other end of the left power assist rod 4.1 is hinged with one end of the right power assist rod 4.2 to form an A-shaped ladder body; the outer surface of the left power assist rod 4.1 is further provided with a power assist hinging piece 4.3 connected to the outer surface of the right power assist rod 4.2;

a left power assist footboard 4.4 from which left steps 1.1 can be extended is hinged in the left power assist rod 4.1, and a right power assist footboard 4.5 from which right steps 2.1 can be extended is hinged in the right power assist rod 4.2; the left power assist footboard 4.4 is provided with a first reset spring 4.6 connected to the top of the right ladder body 2; a left power assist push rod 4.7 is hinged downward on the end of the left power assist footboard 4.4 close to the right power assist footboard 4.5, and the top of the left power assist push rod 4.7 is further provided with a left hinging piece 4.8 hinged with the left ladder body 1; the left power assist footboard 4.4 can move up and down around the hinging portion of the left power assist rod 4.1 and drive the left power assist push rod 4.7 to move; the right power assist footboard 4.5 is provided with a second reset spring 4.9 connected to the top of the left ladder body 1; a right power assist push rod 4.10 is hinged downward on the end of the right power assist footboard 4.5 close to the left power assist footboard 4.4, and the top of the right power assist push rod 4.10 is further provided with a right hinging piece 4.11 hinged with the right ladder body 2; the right power assist footboard 4.5 can move up and down around the hinging portion of the right power assist rod 4.2 and drive the right power assist push rod 4.10 to move.

Preferably, the left power assist footboard 4.4 and the right power assist footboard 4.5 have the same structure; the left power assist footboard 4.4 comprises an outer frame 4.4a, and a cross bar 4.4b is disposed at the middle of the outer frame 4.4a to divide the outer frame into a connecting portion 4.4c and a foot portion 4.4d; the foot portion 4.4d is provided with a plurality of foot rods 4.4e perpendicular to the cross bar 4.4b; the outer side of the end of the connecting portion 4.4c away from the foot portion 4.4d is hinged with the inner wall of the left power assist rod 4.1, and the inner side thereof is hinged with the top of the left power assist push rod 4.7; the cross bar 4.4b is connected to the end of the first reset spring 4.6.

Preferably, the foot portion 4.4d of the left power assist footboard 4.4 is extended out of the left step 1.1, and left steps 1.1 are all disposed at the lower portion of the left power assist footboard 4.4, and the left step 1.1 at the top is disposed at the lower portion of the left power assist footboard 4.4 and abuts the left power assist footboard 4.4.

Preferably, one end of the left hinging piece 4.8 is hinged with the connecting portion of the left power assist rod 4.1 and the left ladder body 1, and the other end thereof is hinged with a first hinging hook; the surface of the left power assist push rod 4.7 is provided with a first hinging bolt 4.7a corresponding to the first hinging hook, so that the left hinging piece 4.8 and the left power assist push rod 4.7 are detachably connected.

Preferably, one end of the power assist hinging piece 4.3 is hinged with the outside of the left power assist rod 4.1, and the other end thereof is provided with a second hinging hook; the outside of the right power assist rod 4.2 is provided with a second hinging bolt 4.2a corresponding to the second hinging hook, so that the right power assist rod 4.2 and the power assist hinging piece 4.3 are detachably connected.

Preferably, the bottom of the left power assist push rod 4.7 and the right power assist push rod 4.10 are further provided with a non-slip cover for increasing friction.

Preferably, a seat 5 is provided on the top hinging portion of the left ladder body 1 and the right ladder body 2. The worker can sit or stand on the power assist footboard, and tools such as ash buckets can be placed on the power assist footboard.

Preferably, the left hinging piece 4.8 of the left ladder body 1 and the right hinging piece 4.11 of the right ladder body 2 are both provided with a decoupling distance adjustment orifice, so that the movement distance of the ladder can be appropriately adjusted. The decoupling distance adjustment orifice is comprised of a plurality of hinging hooks disposed at one end of the left hinging piece 4.8 and the right hinging piece 4.11.

Preferably, the lower portion of the left power assist push rod 4.7 and the right power assist push rod 4.10 are provided with a foldable hinging chain, which can shorten the length of the power assist push rod, and fit the fold of the movable ladder for convenient carrying.

In the specific implementation, the worker can straddle on the seat 5 of the top of the left ladder body 1 and the right ladder body 2 to conduct construction (painting, oil painting, wiring, searching, etc.), with two feet respectively stepped on the left power assist footboard 4.4 and the right power assist footboard 4.5; when you need to move the ladder body to the left or right, just step your foot on the left power assist footboard 4.4 and the right power assist footboard 4.5 up and down in reciprocation, and the stepping force from the left power assist footboard 4.4 and the right power assist footboard 4.5 push the left power assist push rod 4.7 and the right power assist push rod 4.10 to move in the opposite direction with the left step 1.1 and right step 2.1 through the left hinging piece 4.8 and the right hinging piece 4.11, so as to drive the ladder body to move to the designated position.

When the ladder body is static, the spring tension of the first reset spring 4.6 and the second reset spring 4.9 is offset by the worker's foot force and weight; when the ladder body needs to be moved, the worker lifts the foot, and the first reset spring 4.6 and the second reset spring 4.9 generate a reaction force, and the left power assist footboard 4.4 and the right power assist footboard 4.5 rebounds with the footsteps; so stepping the left power assist footboard 4.4 and the right power assist footboard 4.5 up and down in reciprocation, which enables the stepping force to be converted into the thrust of the left power assist push rod 4.7 and the right power assist push rod 4.10, so as to reversely push the ladder body to move to the left or right.

When the construction needs to be transited, the left hinging piece 4.8 is decoupled from the left power assist push rod 4.7, the right hinging piece 4.11 is decoupled from the right power assist push rod 4.10, the power assist hinging piece 4.3 is decoupled from the right power assist rod 4.2, which enables the left power assist footboard 4.4 and the right power assist footboard 4.5 to be folded upward, and the ladder body is folded for convenient transportation.

The invention and the embodiments thereof have been described hereinabove, and the description is not limited thereto; only one of the embodiments of the invention is shown in the figures, and the actual structure is not limited thereto. In general, any structure modes and embodiments similar to the technical solutions of the invention made by those of ordinary skill in the art without departing from the purpose of the invention shall all fall within the protection scope of the invention.

1. A foot-assisted movable engineering ladder, comprising a herringbone ladder body, wherein the ladder body comprises a left ladder body and a right ladder body hinged with each other at the top; the left ladder body is provided with a plurality of left steps in parallel from top to bottom, and the right ladder body is provided with a plurality of right steps corresponding to the left steps in parallel from top to bottom; the bottom of the left ladder body and the right ladder body are respectively provided with guiding wheels;
the upper portion of the left ladder body close to the hinging portion with the right ladder body is provided with a power assist component; the power assist component comprises a left power assist rod hinged with the left ladder body at one end and a right power assist rod hinged with the right ladder body at one end; the other end of the left power assist rod is hinged with one end of the right power assist rod to form an A-shaped ladder body; the outer surface of the left power assist rod is further provided with a power assist hinging piece connected to the outer surface of the right power assist rod;
a left power assist footboard from which left steps can be extended is hinged in the left power assist rod, and a right power assist footboard from which right steps can be extended is hinged in the right power assist rod; the left power assist footboard is provided with a first reset spring connected to the top of the right ladder body; a left power assist push rod is hinged downward on the end of the left power assist footboard close to the right power assist footboard, and the top of the left power assist push rod is further provided with a left hinging piece hinged with the left ladder body; the left power assist footboard can move up and down around the hinging portion of the left power assist rod and drive the left power assist push rod to move; the right power assist footboard is provided with a second reset spring connected to the top of the left ladder body; a right power assist push rod is hinged downward on the end of the right power assist footboard close to the left power assist footboard, and the top of the right power assist push rod is further provided with a right hinging piece hinged with the right ladder body; the right power assist footboard can move up and down around the hinging portion of the right power assist rod and drive the right power assist push rod to move.

2. The foot-assisted movable engineering ladder according to claim 1, wherein the left power assist footboard and the right power assist footboard have the same structure; the left power assist footboard comprises an outer frame, and a cross bar is disposed at the middle of the outer frame to divide the outer frame into a connecting portion and a foot portion; the foot portion is provided with a plurality of foot rods perpendicular to the cross bar; the outer side of the end of the connecting portion away from the foot portion is hinged with the inner wall of the left power assist rod, and the inner side thereof is hinged with the top of the left power assist push rod; the cross bar is connected to the end of the first reset spring.

3. The foot-assisted movable engineering ladder according to claim 2, wherein the foot portion of the left power assist footboard is extended out of the left step, and left steps are all disposed at the lower portion of the left power assist footboard, and the left step at the top is disposed at the lower portion of the left power assist footboard and abuts the left power assist footboard.

4. The foot-assisted movable engineering ladder according to claim 1, wherein one end of the left hinging piece is hinged with the connecting portion of the left power assist rod and the left ladder body, and the other end thereof is hinged with a first hinging hook; the surface of the left power assist push rod is provided with a first hinging bolt corresponding to the first hinging hook, so that the left hinging piece and the left power assist push rod are detachably connected.

5. The foot-assisted movable engineering ladder according to claim 1, wherein one end of the power assist hinging piece is hinged with the outside of the left power assist rod, and the other end thereof is provided with a second hinging hook; the outside of the right power assist rod is provided with a second hinging bolt corresponding to the second hinging hook, so that the right power assist rod and the power assist hinging piece are detachably connected.

6. The foot-assisted movable engineering ladder according to claim 1, wherein the bottom of the left power assist push rod and the right power assist push rod are further provided with a non-slip cover for increasing friction.

7. The foot-assisted movable engineering ladder according to claim 1, wherein a seat is provided on the top hinging portion of the left ladder body and the right ladder body.

8. The foot-assisted movable engineering ladder according to claim 1, wherein the left hinging piece of the left ladder body and the right hinging piece of the right ladder body are both provided with a decoupling distance adjustment orifice.

9. The foot-assisted movable engineering ladder according to claim 1, wherein the lower portion of the left power assist push rod and the right power assist push rod are provided with a foldable hinging chain.
